(19) United States
(12) Patent Application Publication
(10) Pub. No.: US 2003/0234249 A1
(43) Pub. Date: Dec. 25, 2003

(54) Method of destroying data on CD media

(76) Inventors: Jenn-Shing Wang, Yungkang City (TW); Jiann-Shing Jeng, Lujhu Township (TW); Yao-Feng Liang, Sinjhuang City (TW)

Correspondence Address: Far East College, P.O. Box No. 6-57, Junghe, Taipei, 235, TW

(21) Appl. No.: 10/457,418

(22) Filed: Jun. 10, 2003

(30) Foreign Application Priority Data
Jun. 20, 2002 (TW) 091113430

(51) Int. Cl. H05B 6/64

(52) U.S. Cl. 219/679; 219/678

(57) ABSTRACT

The present invention relates to a method of destroying data on CD media, particularly apply to destroy a metal reflective layer of a CD, so that data cannot be accessed out of the CD. The data destruction by the method of destroying the metal reflective layer of CD media employs microwave action on the CD media. Therefore, the present invention can completely and rapidly destroy data recorded on any CD media, in addition, is simple and convenient equipment for easy operation.

### BACKGROUND OF THE INVENTION

1) Field of the Invention

The present invention relates to a method of destroying data on a compact disc (CD) useless, more especially to a method which is able to entirely and efficiently destroy data recorded on a CD by means of microwave. Furthermore, the method of present invention possesses the confidential, simply and convenient, quantity operation and lower cost effects.

2) Description of the Prior Art

Prior to the CD disposal, those disc media have to be destroyed under the situations, such as damaged during the production process, faulty or stock goods, bootleg CDs, sensitive or classified data recorded on a CD useless that needs prevention of being revealed etc. Mostly, conventional destruction of disc media applied mechanical force, such as punching a hole on a disc, or crushing discs in quantity at a time. However, the way of punching a hole on a disc cannot assure that the disc is unreadable, as someone else can probably find a way to read most of the data off of it. In addition, both ways of punching a hole on a disc and crushing the whole disc are unfavorable for the sequential process of recycling the substrate of compact discs, printed layers for example, especially those discs, which can originally be recycled back as substrates for making disc products. Now that both of said disc destruction ways only enable those discs useless to be utilized as engineering plastics of lower economic values, instead of applicable its optical nature.

In view of the foregoing drawbacks, some improvement methods have been patented in official gazettes or miscellanies from in-country and abroad. For instance, prior applications of U.S. Pat. Nos. 5,306,349 and 6,066,229 apply chemical solvents to pre-treated discs, of which substrates and thin films can sequentially be separated by means of ultrasonic vibration. In addition, prior applications such as U.S. Pat. No. 5,619,898 and “Treatment for Discarded Compact Discs and Related Device and Compact Disc” of Taiwan Patent Publication No. 464595 disclose mechanical force to remove cladding layers of discs; whereas “Recycle of Compact Disc-Record” of Taiwan Patent Publication No. 443949 discloses a mechanical crushing method and then separate out various disc materials by chemical solvents for re-use. However, the afore-mentioned methods using chemical solvents easily incur sequential problems involving regeneration of liquid chemical waste and pollution discharge; whereas the methods using mechanical force tends to damage the substrate of the disc materials and therefore failing to entirely recycle and re-make CDs. The methods of prior applications with associated equipments on the design of CD recycling, become expensive, heavy, time-consuming, which are complicated and inconvenient to be operated in destroying data on CDs useless. The most drawback of the prior applications is that recorded data on CDs are hard to be rapidly and entirely destroyed. Besides, other methods involve chemical solvent process, making worse material property of polycarbonate substrates therefore failing to be applied for valuable optical purposes, moreover, it may even affect mechanical properties of those substrates so as to reduce the reusing value thereof. In addition, the disposal of liquid chemical waste is another noticeable problem for all.

The recycling problem will not be further discussed or judged herein, instead, the present invention proposes a better method of destroying data on CDs media in view of those drawbacks of afore-mentioned applications.

### SUMMARY OF THE INVENTION

The primary objective of the present invention is to provide a method of destroying data on CDs useless, aims at employing the “selective” characteristic of microwave destroy only metal reflective layer on CDs with focused energy. The method of the invention achieves the objective of destroying the metal reflective layer of CDs to enable the data failing to be accessed, as none of CD data can be detected or identified. The method of the invention has several advantages, such as easily to be operated, with lower cost, high effectiveness, favorable for sequential recycling processes, safety and security.

To enable a further understanding of the structural features and the technical contents of the present invention, the brief description is followed by the detailed description of the preferred embodiment.

### DETAILED DESCRIPTION OF THE PREFERRED EMBODIMENTS

The destruction method of data on a CD useless applies a CD-R to be placed into a microwave oven by dint of microwave with a frequency of 2450 MHZ with a power of 350W after five seconds, consequently, a reflective layer and a dye layer of the CD-R are partial separated, and in addition, vertical cracks also are generated on inseparable parts of the reflective layer. Therefore, the present invention can achieve the objective of entirely and rapidly destroying data on CD medias.

Moreover, the CD media, which can be destroyed by dint of aforementioned microwave, comprise music CD-ROM, Video-CD, CD-interactive(CD-I), digital versatile disc (DVD)-Video, digital versatile disc-read only memory (DVD-ROM), CD-R, write-once read many (WORM), digital versatile disc-random access memory (DVD-RAM), CD-RW, magneto-optical (MO), mini-disc (MD) and digital versatile disc re-writable (DVD-RW). Each kind of said CD media possesses the metal reflective layer to reflect laser beam, moreover, a thin film formed in the reflective layer is easily to be destroyed in a microwave field, so that data on the CD media cannot be read out and/or copied. Namely, the present invention is applicable to the kind of optical recordable disc medias with the metal reflective layer.

The method of destroying data on CDs useless according to the present invention can achieve the destruction objective by placing CDs into a microwave environment through the following categories: batch mode by sending many CDs at a time, semi-continuous mode by sending many CDs by conveyor belts and retrieving them out of the microwave environment after a certain of time, or continuous mode by consecutively sending CDs into the microwave environment and retrieving them out one by one.

Furthermore, electromagnetic wave, which frequency is within the microwave range, should have the effect of destroying the metal reflective layer of CDs useless.

In addition, the range of electromagnetic wave, which have the effect of destroying the metal reflective layer of CDs, or can act with a dye layer, or a dielectric layer, or an optical recording layer to generate one of the phenomena of dissolution, evaporation, and phase change. Therefore, the range electromagnetic wave, which is able to result in data destruction, is applicable to the range of the method of the present invention.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A method of destroying data on CD media comprising the steps of:
(a) placing CDs into microwave environment;
(b) destroying a reflective layer of the CDs by dint of microwave action;
(c) enabling data on the CDs failing to be accessed.

2. The method of destroying data on CD media of claim 1, wherein the microwave action is applicable to optical recordable CD media with a metal reflective layer, such as CD, CD-ROM, Video-CD, CD-I, DVD-Video, DVD-ROM, CD-R, WORM, DVD-RAM, CD-RW, MO, MD and DVD-RW.

3. The method of destroying data on CD media of claim 1, wherein the way of placing CDs into microwave environment comprising categories of batch mode, semi-continuous mode and continuous mode.

4. A method of destroying data on CD media of claim 1, wherein the microwave environment can be replaced in electromagnetic wave environment, which frequency is within the microwave ranges.
